(19) United States
(12) Patent Application Publication
(10) Pub. No.: US 2025/0300417 A1
(43) Pub. Date: Sep. 25, 2025

(54) OPTICAL FREQUENCY COMB GENERATOR WITH OPTO-ELECTRONIC OSCILLATOR AND TUNABLE FILTER

(71) Applicant: University of Central Florida Research Foundation, Inc., Orlando, FL (US)

(72) Inventors: Lawrence Trask, Orlando, FL (US); Srinivas Varma Pericherla, Orlando, FL (US); Peter Delfyett, Orlando, FL (US)

(21) Appl. No.: 19/088,606

(22) Filed: Mar. 24, 2025

Related U.S. Application Data
(60) Provisional application No. 63/568,910, filed on Mar. 22, 2024.

(51) Int. Cl. H01S 3/00; H01S 3/10; H01S 3/1115; H01S 3/13

(52) U.S. Cl. CPC H01S 3/0085; H01S 3/1003; H01S 3/1115; H01S 3/1305

(57) ABSTRACT

A system is provided herein. The system includes an electro-optic modulated (EOM) comb generator including an opto-electronic oscillator (OEO) loop to modulate a continuous-wave seed source and form an EOM comb, a saturable absorber to perform non-linear pulse shaping of the EOM comb, and a tunable filter having resonances matching a frequency spacing of the EOM comb. The tunable filter filters the EOM comb from the saturable absorber to provide an output EOM comb.

### CROSS-REFERENCE TO RELATED APPLICATION

The present application claims the benefit under 35 U.S.C. § 119 (e) of U.S. Provisional Application Ser. No. 63/568,910, filed Mar. 22, 2024, entitled OPTO-ELECTRONIC OSCILLATOR DRIVEN ELECTRO-OPTIC MODULATOR BASED OPTICAL FREQUENCY COMB, naming Lawrence Trask, Srinivas Varma Pericherla, and Peter Delfyett as inventors, which is incorporated herein by reference in the entirety.

### TECHNICAL FIELD

The present disclosure relates generally to generating optical combs and, more particularly, to generating an electro-optic modulated comb using an opto-electronic oscillator.

### BACKGROUND

Optical frequency combs have become increasingly important tools in various fields, including metrology, spectroscopy, and telecommunications. These combs consist of a series of equally spaced frequency lines, providing precise frequency references across a broad spectral range. Traditional methods of generating optical frequency combs often involve complex setups or specialized laser sources, which can limit their practical applications. There is therefore a need to develop systems and methods to address the above deficiencies.

### SUMMARY

In embodiments, the techniques described herein relate to a system, including an electro-optic modulated (EOM) comb generator including an opto-electronic oscillator (OEO) loop to modulate a continuous-wave seed source and form an EOM comb; a saturable absorber to perform non-linear pulse shaping of the EOM comb; and a tunable filter having resonances matching a frequency spacing of the EOM comb, where the tunable filter filters the EOM comb from the saturable absorber to provide an output EOM comb.

In embodiments, the techniques described herein relate to a system, further including an interferometer for detecting a carrier envelope offset signal associated with the output EOM comb.

In embodiments, the techniques described herein relate to a system, where the interferometer provides a feedback signal to the EOM comb generator for temporal stability.

In embodiments, the techniques described herein relate to a system, where the interferometer provides a measurement of an absolute optical frequency offset of the output EOM comb.

In embodiments, the techniques described herein relate to a system, further including an amplifier to amplify the EOM comb from the tunable filter.

In embodiments, the techniques described herein relate to a system, further including a pulse picker between the tunable filter and the amplifier to selectively pick pulses in the output EOM comb.

In embodiments, the techniques described herein relate to a system, further including a dispersive filter between the tunable filter and the amplifier.

In embodiments, the techniques described herein relate to a system, where the dispersive filter includes a spatial light modulator.

In embodiments, the techniques described herein relate to a system, where the saturable absorber includes a nonlinear amplifying loop mirror (NALM).

In embodiments, the techniques described herein relate to a system, where the tunable filter includes a stationary mirror; and a movable mirror parallel to the stationary mirror, where a separation distance between the stationary mirror and the movable mirror is adjustable.

In embodiments, the techniques described herein relate to a system, where the separation distance between the stationary mirror and the movable mirror is controlled to match cavity resonances of the tunable filter with the output EOM comb.

In embodiments, the techniques described herein relate to a system, where the EOM comb generator includes a light source to generate an optical signal; an intensity modulator to modulate an intensity of the optical signal from the light source based on a radio-frequency (RF) drive signal; a frequency-locking loop to maintain an optical frequency of the optical signal at a target optical frequency, where the target optical frequency corresponds to a resonance frequency of a periodic optical filter in the frequency-locking loop; an optoelectronic oscillator (OEO) loop including a photodetector to generate the RF drive signal from a portion of the optical signal from the frequency-locking loop; and a tunable phase shifter to introduce a phase shift to the RF drive signal to select a resonance frequency of the OEO loop corresponding to a harmonic of the resonance frequency of the periodic optical filter, where the RF drive signal includes the resonance frequency of the OEO loop; and one or more phase modulators in series to generate the EOM comb by modulating a portion of the optical signal from the frequency-locking loop based on the RF drive signal.

In embodiments, the techniques described herein relate to a system, including an electro-optic modulated (EOM) comb generator including an opto-electronic oscillator (OEO) loop to modulate a continuous-wave seed source and form an EOM comb, where the EOM comb generator includes a light source to generate an optical signal; an intensity modulator to modulate an intensity of the optical signal from the light source based on a radio-frequency (RF) drive signal; a frequency-locking loop to maintain an optical frequency of the optical signal at a target optical frequency, where the target optical frequency corresponds to a resonance frequency of a periodic optical filter in the frequency-locking loop, where the frequency-locking loop includes one or more phase modulators in series prior to the periodic optical filter to modulate a portion of the optical signal based on the RF drive signal to produce the EOM comb; and an optoelectronic oscillator (OEO) loop including a photodetector to generate the RF drive signal from a portion of the EOM comb from the frequency-locking loop; and a tunable phase shifter to introduce a phase shift to the RF drive signal to select a resonance frequency of the OEO loop corresponding to a harmonic of the resonance frequency of the periodic optical filter, where the RF drive signal includes the resonance frequency of the OEO loop; and a saturable absorber to perform non-linear pulse shaping of the EOM comb to provide an output EOM comb.

In embodiments, the techniques described herein relate to a system, further including an interferometer for detecting a carrier envelope offset signal associated with the output EOM comb.

In embodiments, the techniques described herein relate to a system, where the interferometer provides a feedback signal to the EOM comb generator for temporal stability.

In embodiments, the techniques described herein relate to a system, where the interferometer provides a measurement of an absolute optical frequency offset of the output EOM comb.

In embodiments, the techniques described herein relate to a system, where the saturable absorber includes a nonlinear amplifying loop mirror (NALM).

In embodiments, the techniques described herein relate to a system, where the tunable filter includes a stationary mirror; and a movable mirror parallel to the stationary mirror, where a separation distance between the stationary mirror and the movable mirror is adjustable.

In embodiments, the techniques described herein relate to a system, where the separation distance between the stationary mirror and the movable mirror is controlled to match cavity resonances of the tunable filter with the output EOM comb.

In embodiments, the techniques described herein relate to a method, including modulating a continuous-wave seed source with an electro-optic modulated (EOM) comb generator including an opto-electronic oscillator (OEO) loop to form an EOM comb; performing non-linear pulse shaping of the EOM comb with a saturable absorber; and filtering the EOM comb with a tunable filter having resonances matching a frequency spacing of the EOM comb to provide an output EOM comb.

In embodiments, the techniques described herein relate to a method, further including amplifying the output EOM comb.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of a comb-generation system, in accordance with one or more embodiments of the present disclosure.

FIG. 2 illustrates a block diagram of an EOM comb generator, in accordance with one or more embodiments of the present disclosure.

FIG. 3 illustrates a block diagram of a portion of the comb-generation system depicting a saturable absorber, in accordance with one or more embodiments of the present disclosure.

FIG. 4 illustrates a block diagram of a portion of the comb-generation system including a tunable filter, in accordance with one or more embodiments of the present disclosure.

FIG. 5A illustrates a block diagram of the comb-generation system with an interferometer, in accordance with one or more embodiments of the present disclosure.

FIG. 5B illustrates a block diagram of an EOM comb generator with an additional phase shifter, in accordance with one or more embodiments of the present disclosure.

FIG. 6 illustrates a block diagram of an EOM comb generator with repositioned cascading phase shifting units, in accordance with one or more embodiments of the present disclosure.

FIG. 7 illustrates a flowchart of a method for generating an optical frequency comb, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

The present disclosure relates to systems and methods for generating optical frequency combs. In some cases, a comb-generation system may include an electro-optic modulated (EOM) comb generator that produces an EOM comb. The EOM comb generator may include an optoelectronic oscillator (OEO) loop to modulate a continuous-wave seed source and provide self-referenced RF feedback.

In some cases, the comb-generation system may include a saturable absorber to perform non-linear pulse shaping of the EOM comb. The comb-generation system may further include a tunable filter having resonances (e.g., cavity resonances) matching a frequency spacing of the EOM comb. The tunable filter may filter the EOM comb from the saturable absorber to provide an output EOM comb.

The comb-generation system disclosed herein may offer several advantages. For example, the system may generate a spectrally-pure electrical oscillation using the OEO loop to modulate a continuous-wave laser when forming the EOM comb. In some cases, the comb-generation system may be fabricated with all fiber components or fiber-connected components, which may lend itself to easy integration with other systems.

The comb-generation system may provide a measurement of the absolute frequency offset of the output EOM comb without any electronic or external references needed. Additionally, the system may be self-starting, self-referencing, and self-stabilizing.

In some cases, the components of the comb-generation system may be modified or replaced to support operation at any selected wavelength or spectral range. This flexibility may allow the system to be adapted for various applications.

The comb-generation system may be used for a wide range of applications. These applications may include, but are not limited to, astrophotonics, metrology, LIDAR, optical clocks, wavelength division multiplexing communications, femtosecond laser machining, or low noise microwave signal generation.

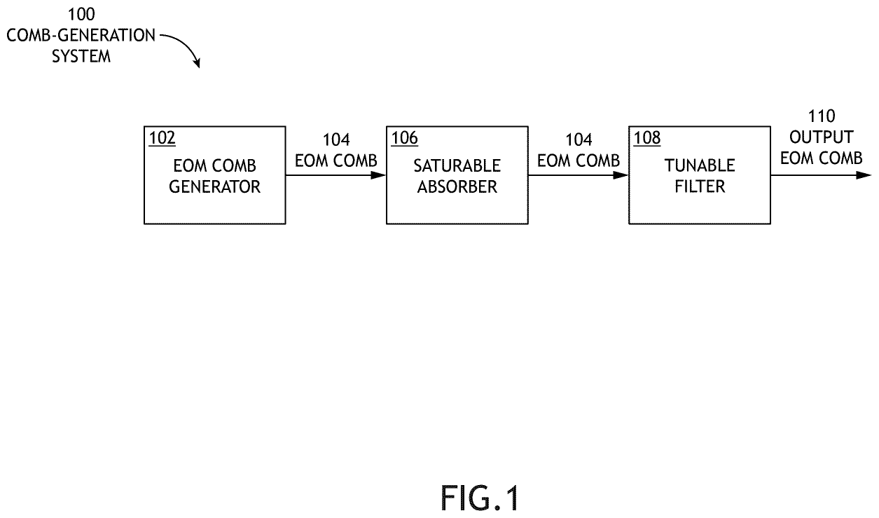

Referring now to FIGS. 1-7, systems and methods for generating an EOM comb are described in greater detail, in accordance with one or more embodiments of the present disclosure.

FIG. 1 illustrates a block diagram of the comb-generation system 100, in accordance with one or more embodiments of the present disclosure. In some embodiments, the comb-generation system 100 includes an electro-optic modulated (EOM) comb generator 102, a saturable absorber 106, and a tunable filter 108.

In some embodiments, the EOM comb generator 102 generates an EOM comb 104 using a periodic optical filter and an OEO loop, which generates an internal radio-frequency (RF) drive signal for optical carrier modulation and thus avoids the use of an external RF oscillation signal. Such an EOM comb generator 102 may be referred to herein as an OEO EOM comb generator or simply as an OEO EOM. A periodic optical filter stabilized tunable comb generator is generally described in U.S. Pat. No. 10,942,417 issued on Mar. 9, 2021 and U.S. Pat. No. 10,585,332 issued on Mar. 10, 2020, both of which are incorporated by reference in their entireties. In some embodiments, the EOM comb generator 102 includes a periodic optical filter stabilized tunable comb generator as described in U.S. Pat. No. 10,942,417 issued on Mar. 9, 2021 and/or U.S. Pat. No. 10,585,332.

In some embodiments, the saturable absorber 106 performs non-linear pulse shaping of the EOM comb 104 such as, but not limited to, suppressing pulse pedestals or pulse reshaping.

After passing through the saturable absorber 106, the shaped EOM comb 104 may be directed to the tunable filter 108, which may filter the EOM comb 104 from the saturable absorber 106 to provide the output EOM comb 110. For example, the tunable filter 108 may have resonances matching a frequency spacing of the EOM comb 104, which may maintain the comb structure while allowing for further filtering and potential stabilization of comb lines.

The resonances of the tunable filter 108 can be adjusted to align with the comb spacing using any technique including, but not limited to, mechanical or thermal tuning mechanisms. This tunability allows for fine control over which comb lines are transmitted and which are suppressed. By carefully aligning the cavity resonances with the desired comb lines, unwanted frequency components or noise between the comb lines can be effectively filtered out.

The output EOM comb 110 that emerges from the tunable filter 108 may thus be a refined version of the EOM comb 104 with improved spectral purity, stability, and potentially a modified spectral envelope tailored to the specific application requirements. This filtered and potentially stabilized output EOM comb 110 can then be used directly or may undergo further processing or amplification stages depending on the intended use of the optical frequency comb system.

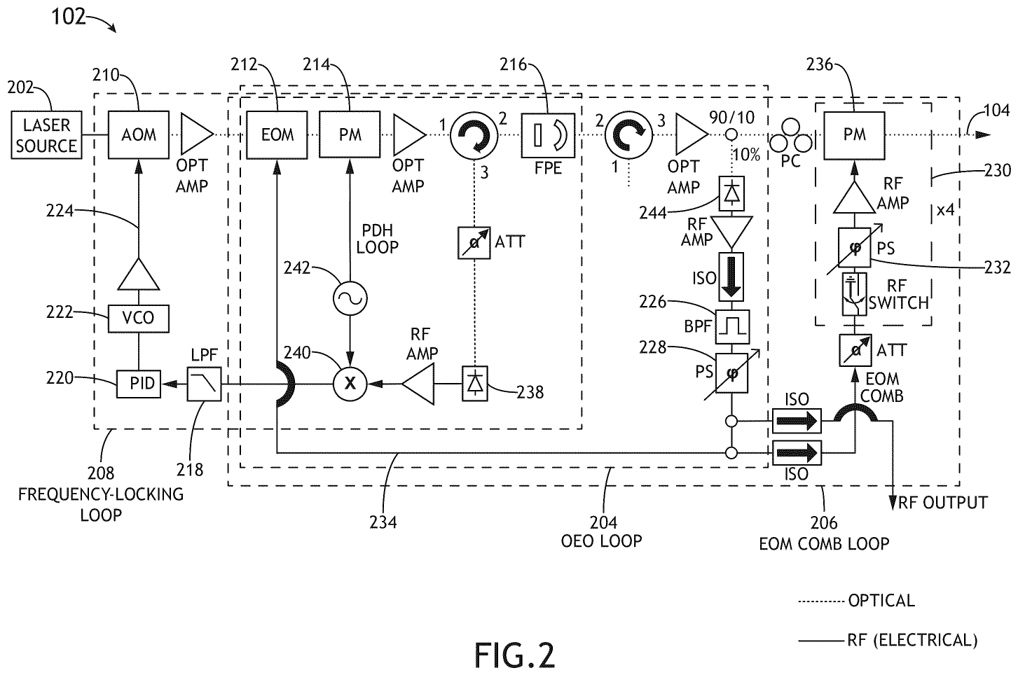

Referring now to FIGS. 2-6, components of the comb-generation system 100 are described in greater detail, in accordance with one or more embodiments of the present disclosure.

FIG. 2 illustrates a block diagram of an EOM comb generator 102, in accordance with one or more embodiments of the present disclosure.

In some embodiments, the EOM comb generator 102 may generate the EOM comb 104 through the coordinated operation of a frequency-locking loop 208, an OEO loop 204, and an EOM comb loop 206. The laser source 202 may provide a continuous-wave optical signal that serves as the initial seed for the comb generation process. The laser source 202 may be implemented using any type of laser technology known in the art, including but not limited to a distributed feedback (DFB) laser, an external cavity diode laser (ECDL), a fiber laser, (e.g., an erbium-doped fiber laser, or the like), or a semiconductor laser, such as a vertical-cavity surface-emitting laser (VCSEL). The laser source 202 may be designed to operate at any suitable wavelength depending on the application. In some embodiments, the laser source 202 provides an optical signal with a wavelength around 1550 nm. The output power of the laser source 202 can be varied, typically ranging from a few milliwatts to several hundred milliwatts.

This optical signal from the laser source 202 may be directed into the frequency-locking loop 208, which may maintain the optical frequency (e.g., wavelength) at a target frequency corresponding to a resonance of the periodic optical filter 216. For example, EOM comb generator 102 may include an acousto-optic modulator 210 to adjust (e.g., sweep) the optical frequency of the optical signal from the laser source 202 across a resonance of the periodic optical filter 216 and an electro-optic intensity modulator 212 (e.g., a Mach-Zender Modulator (MZM), or any suitable modulator) to carve out pulses from the continuous-wave optical signal.

The frequency-locking loop 208 may then include a periodic optical filter 216 to filter the modulated light (e.g., the light modulated by the acousto-optic modulator, the electro-optic intensity modulator, and the phase modulator). The periodic optical filter 216 may include any type of resonant filter known in the art including, but not limited to, a high-finesse Fabry-Perot etalon (FPE). The frequency-locking loop 208 may further include control components to ensure that the optical frequency is confined to the peak resonance (e.g., a peak of the etalon resonance) of the periodic optical filter 216. Further, the frequency-locking loop 208 may utilize any control technique suitable for ensuring that the optical frequency of light entering the periodic optical filter 216 matches a resonance of the periodic optical filter 216.

As an illustration, FIG. 2 depicts a non-limiting example in which the frequency-locking loop 208 is configured as a Pound-Drever-Hall (PDH) loop. The PDH technique may provide a precise method for locking the laser frequency to a resonance of the periodic optical filter 216. In the PDH configuration, the frequency-locking loop 208 may include a phase modulator 214 to apply a high-frequency phase modulation to the optical signal, creating sidebands. When the modulated light is reflected from the periodic optical filter 216, the interaction between the carrier and sidebands may be used to generate an error signal that indicates the frequency deviation from the filter resonance. For example, the reflected light detected by a photodetector 238, which converts the optical signal to an electrical signal. This electrical signal may then optionally be amplified (e.g., using an RF amplifier (RF AMP) as shown in FIG. 2) and be demodulated with the same frequency used for the phase modulation, typically using a mixer 240 and a local oscillator 242 as shown in FIG. 2, though this is illustrative and not limiting. The resulting error signal may be filtered by a low-pass filter 218 to remove high-frequency components. The filtered error signal may then be fed into the PID controller 220, which may generate a control signal for the acousto-optic modulator to adjust the laser frequency. For example, the frequency-locking loop 208 may include a voltage-controlled oscillator (VCO) 222 to generate control signals 224 to the acousto-optic modulator 210. This closed-loop feedback system may continuously monitor and correct the laser frequency, maintaining it at the desired resonance of the periodic optical filter 216. The PDH technique may allow for precise frequency locking, potentially achieving sub-Hertz stability levels in some implementations. However, it is to be understood that the depiction of PDH locking in FIG. 2 is provided solely for illustrative purposes and should not be interpreted as limiting.

The frequency-locked optical signal from the frequency-locking loop 208 may then be split in the OEO loop 204, where a portion is utilized to generate a self-referenced RF drive signal 234 for the electro-optic intensity modulator 212. For example, FIG. 2 depicts a portion of the frequency-locked optical signal from the frequency-locking loop 208 that is converted to an electrical signal by a photodetector 244, filtered by a bandpass filter 226, and tuned with a phase shifter 228. The phase shifter 228 may introduce a phase shift to the RF drive signal 234 to select a resonance frequency of the OEO loop corresponding to a harmonic of the resonance frequency of the periodic optical filter 216. Tuning the phase shifter 228 allows for an electrical oscillation in the RF drive signal 234 to correspond to integer multiples of the frequency spacing of the periodic optical filter 216. Put another way, the frequency of the RF drive signal 234 may correspond to a harmonic of the resonance frequency of the periodic optical filter 216.

Another portion of the frequency-locked optical signal may be directed to the EOM comb loop 206. In this loop, the RF drive signal 234 may be used to drive a series of cascaded phase shifting units 230 that form the EOM comb 104. For example, the cascading phase shifting units 230 generate additional comb lines with a sinusoidal chirp. A cascaded phase shifting unit 230 may include any combination of an RF switch, a cascaded phase shifter 232, or a cascaded phase modulator 236. For example, a cascaded phase modulator 236 may impress phase modulation onto the optical signal based on the RF drive signal 234, while a cascaded phase shifter 232 may ensure efficient comb generation. The EOM comb generator may include any number of cascading phase shifting units 230. As an illustration, FIG. 2 depicts a configuration with four cascading phase shifting units 230. Further, the resulting EOM comb 104 may have pulses with any duty cycle such as, but not limited to, a 50% duty cycle.

By integrating the laser source 202, frequency-locking loop 208, OEO loop 204, and EOM comb loop 206 in this manner, the EOM comb generator 102 may produce a stable and coherent EOM comb 104. The use of the OEO loop 204 to generate the RF drive signal 234 may allow for the creation of a self-contained comb generator that does not require an external RF source. Additionally, the frequency-locking loop 208 may help ensure long-term stability of the comb, while the cascaded phase modulations in the EOM comb loop 206 may enable the generation of a broad optical frequency comb.

As shown in FIG. 2, the EOM comb generator 102 (and the comb-generation system 100 more generally) may also include various components to condition optical or RF signals. For example, FIG. 2 depicts various optical amplifiers (OPT AMP) and RF amplifiers (RF AMP) to amplify optical and RF signals, respectively. These amplifiers may be formed using any technology known in the art. As an illustration, the optical amplifiers may be, but are not required to be, formed as erbium-doped fiber amplifiers (EDFAs). As another example, FIG. 2 depicts optical attenuators (ATT) to reduce a signal strength of optical signals when needed. As another example, FIG. 2 depicts circulators and isolators (ISO) to control the distribution of light. As another example, FIG. 2 depicts polarization controllers (PC) providing polarization control of light.

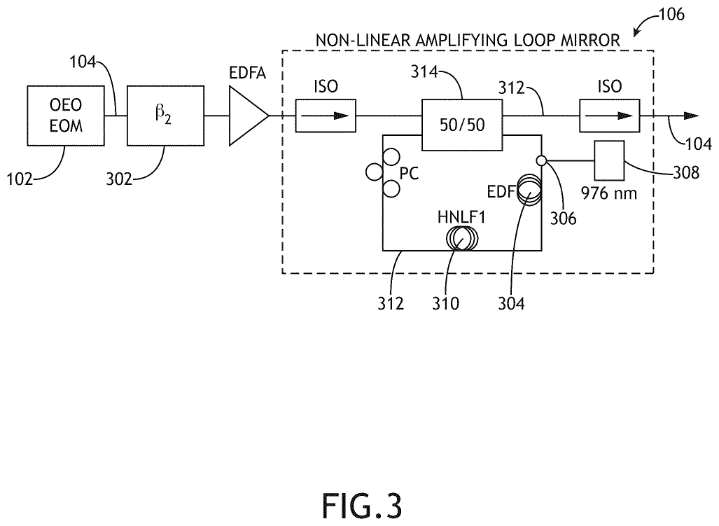

FIG. 3 illustrates a block diagram of a portion of the comb-generation system 100 depicting a saturable absorber 106, in accordance with one or more embodiments of the present disclosure.

In some cases, the EOM comb 104 from the EOM comb generator 102 may be sent to a dispersive filter 302 for compression. The dispersive filter 302 may include any components suitable for modifying a pulse such as, but not limited to, a spatial light modulator (SLM), a dispersive material providing linear chirp, an optical fiber, a pulse stretcher, or a pulse compressor.

After compression by the dispersive filter 302, the EOM comb 104 may optionally be amplified (e.g., via an EDFA or any other optical amplifier suitable for the selected wavelength of the EOM comb 104) be sent to the saturable absorber 106. The saturable absorber 106 may perform any combination of filtering or pulse shaping to improve the contrast of the EOM comb 104. For example, the saturable absorber 106 may perform pulse pedestal suppression, which removes low-intensity portions surrounding the main pulse.

FIG. 3 shows a specific implementation of the saturable absorber 106 as a non-linear amplifying loop mirror (NALM). In some cases, the NALM may include an amplifying fiber 304, a wavelength division multiplexer 306, a pump diode 308, single-mode fiber 312, zero-dispersion highly-nonlinear fiber 310, a coupler 314, and two fiber isolators (ISO). The components of the NALM may be arranged to form a nonlinear amplifying loop mirror configuration.

In some cases, the coupler 314 may be a 50/50 fiber optic coupler that splits the incoming EOM comb 104 into a loop and then recombines light from the loop to provide an output signal. The components of the NALM may be coupled with single-mode fibers 312.

In some cases, the EOM comb 104 may enter the loop through the coupler 314 and propagate through the amplifying fiber 304, which may provide amplification when pumped by the pump diode 308 via the wavelength division multiplexer 306. The amplified signal may then travel through a zero-dispersion highly-nonlinear fiber 310, which may exhibit zero or near-zero chromatic dispersion and high nonlinearity at the operating wavelength of the EOM comb 104. The combination of these properties may allow for efficient nonlinear interactions without temporal broadening of the pulses.

As described throughout the present disclosure, the comb-generation system 100 may generate an EOM comb 104 with any selected wavelength content. In some embodiments, the amplifying fiber 304 is an erbium-doped fiber suitable for operation with wavelengths around 1550 nm. In this configuration, the pump diode 308 may provide pump light at around 976 nm suitable for pumping the erbium-doped amplifying fiber 304. Further, the pump diode 308 may have any suitable optical power. In some cases, the pump diode 308 provides pump light at 1 W or greater.

When pulses from the EOM comb 104 propagate through the zero-dispersion highly-nonlinear fiber 310, they may experience various nonlinear effects. These may include self-phase modulation, cross-phase modulation, and four-wave mixing. The interplay of these effects in the absence of dispersion may lead to spectral broadening and temporal reshaping of the pulses. The composition and/or length of the zero-dispersion highly-nonlinear fiber 310 may be selected based on the specific requirements of the system. In some implementations, lengths ranging from a few meters to several tens of meters may be used. The optimal length may depend on factors such as the pulse energy, repetition rate, and desired nonlinear effects.

As shown in FIG. 3, the NALM may further include various additional components such as, but not limited to, polarization controllers (PCs) or isolators (ISO) to promote efficient operation and mitigate back reflections.

It is to be understood that FIG. 3 and the associated description of the saturable absorber 106 including a NALM is provided solely for illustrative purposes and should not be interpreted as limiting the scope of the present disclosure. The saturable absorber 106 may be formed from any components suitable for non-linear pulse shaping and filtering.

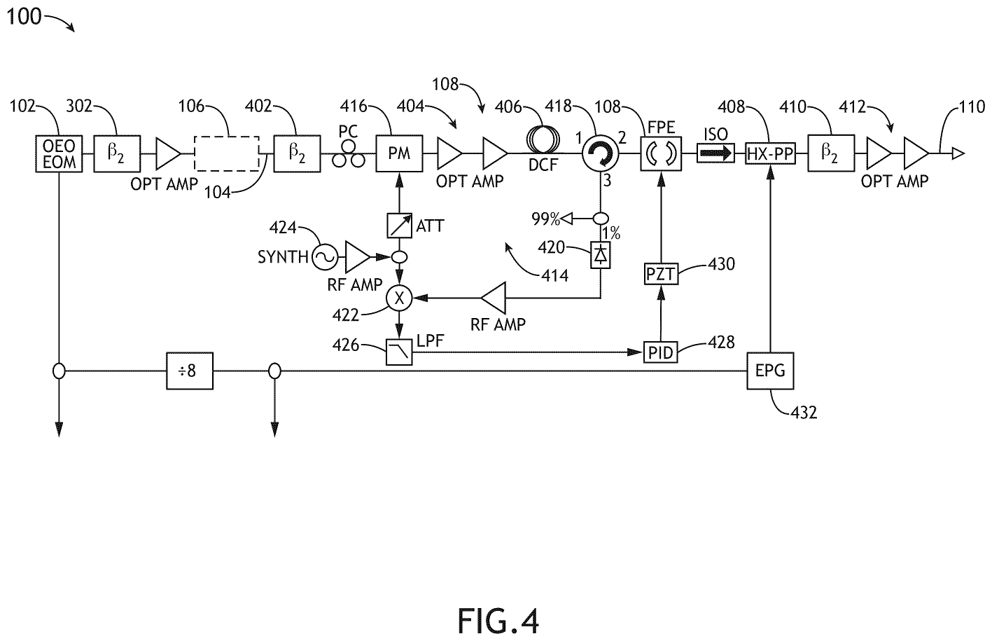

FIG. 4 illustrates a block diagram of a portion of the comb-generation system 100 including the tunable filter 108 and output stage, in accordance with one or more embodiments of the present disclosure.

In some cases, the EOM comb 104 exiting the saturable absorber 106 may be sent to a dispersive filter 402 for further pulse shaping or compression. The dispersive filter 402 may include any components suitable for modifying a pulse such as, but not limited to, a spatial light modulator (SLM), a dispersive material providing linear chirp, an optical fiber, a pulse stretcher, or a pulse compressor.

After passing through the dispersive filter 402, the EOM comb 104 may be amplified by an optical amplifier 404. For example, the optical amplifier 404 may boost the power of the optical signal to compensate for losses in previous stages and ensure sufficient power for subsequent processing. Further, in some embodiments, the optical amplifier 404 may be characterized as a high-power optical amplifier. In some embodiments, the optical amplifier 404 includes an EDFA (e.g., a high-power EDFA) capable of amplifying light up to 2 W. Additionally, the optical amplifier 404 may provide positive or negative dispersion.

The amplified signal may then pass through a dispersion-compensating fiber 406 or other dispersive filter. The dispersion-compensating fiber 406 may be used to compensate for dispersion accumulated in other parts of the system, helping to maintain the temporal profile of the pulses in the EOM comb 104. For example, the dispersion compensating fiber 406 may compensate for the fiber dispersion from the fiber pigtails of components associated with the filter cavity and pulse-picking.

In some cases, the dispersion compensating fiber 406 may be a specialty optical fiber designed with a refractive index profile that provides negative dispersion to counteract the positive dispersion accumulated in other parts of the system. The dispersion compensating fiber 406 may have a dispersion parameter with an opposite sign and similar magnitude to that of standard single-mode fiber used elsewhere in the comb-generation system 100. In some cases, the dispersion compensating fiber 406 may be implemented as a dispersion compensating module that includes a combination of different fiber types or optical components to achieve the desired dispersion profile.

The length and specific parameters of the dispersion compensating fiber 406 may be selected based on the characteristics of the EOM comb 104 and the cumulative dispersion in the system. In some cases, the dispersion compensating fiber 406 may be adjustable or tunable to allow for optimization of the dispersion compensation in real-time.

In some embodiments, EOM comb 104 may enter the tunable filter 108. The tunable filter 108 may include any components suitable for filtering the EOM comb 104. In some embodiments, the tunable filter 108 includes a tunable a Fabry-Perot etalon (FPE). For example, a tunable FPE may include two parallel mirrors with high reflectivity, where the separation distance between the mirrors can be adjusted to tune the resonance frequencies of the cavity.

The mirror separation may be controlled using piezoelectric actuators or any other suitable technique, allowing for precise and rapid tuning of the cavity resonances. In some embodiments, the tunable filter 108 may comprise a stationary mirror and a movable mirror parallel to the stationary mirror. The separation distance between the stationary mirror and the movable mirror may be adjustable to fine-tune the resonance frequencies of the cavity. This adjustability allows the tunable filter 108 to be precisely aligned with the frequency spacing of the EOM comb, ensuring optimal filtering and transmission of the desired comb lines.

FIG. 4 depicts a non-limiting illustration of a control loop 414 for tuning the tunable filter 108. In FIG. 4, the comb-generation system 100 includes a phase modulator 416 (PM) to generate sidebands on the EOM comb 104 that may be reflected from the tunable filter 108 and directed (e.g., via a circulator 418) to a photodiode 420 to generate an electrical signal. This electrical signal may then be demodulated with the same frequency used for the phase modulation, typically using a mixer 422 and a local oscillator 424. The resulting error signal may be filtered by a low-pass filter 426 (LPF) to remove high-frequency components. The filtered error signal may then be fed into a PID controller 428, which may generate a control signal for a piezo-electric transducer 430 (PZT) to adjust a mirror spacing in the tunable filter 108. This locking mechanism may help preserve the comb structure and maintain the spectral purity of the output EOM comb 110.

In some embodiments, the comb-generation system 100 includes one or more amplifiers to amplify the EOM comb 104 prior to the tunable filter 108.

In some embodiments, the comb-generation system 100 includes a pulse picker 408 to reduce the repetition rate of the EOM comb 104. For example, the pulse picker 408 may selectively pick pulses from the EOM comb 104, effectively lowering the repetition rate of the EOM comb 104. The pulse picker 408 may include any components suitable for reducing the repetition rate of the EOM comb 104. In some cases, the pulse picker 408 is a high-extinction pulse picker (HX-PP). This pulse picking process may allow for adjustment of the comb's temporal characteristics to suit specific application requirements. As an illustration, FIG. 4 illustrates a pulse picker 408 driven by an electrical pulse generator 432 (EPG) coupled with the EOM comb generator 102 that provides control signals for dividing a repetition rate of the EOM comb 104 by 8. For instance, such a configuration may change the repetition rate of the EOM comb 104 from ˜10.5 GHz to 1.3125 GHz. However, this is merely an illustration.

After pulse picking, the selected pulses may pass through another dispersive filter 410, which may provide additional pulse shaping or compression, further refining the temporal and spectral characteristics of the comb. The dispersive filter 410 may include any suitable components including, but not limited to, a SLM or a single mode fiber.

As described with respect to FIG. 2, the comb-generation system 100 may have various components to amplify or condition any of the optical or electrical signals. For example, FIG. 4 depicts various optical amplifiers (OPT AMP) to amplify optical signals and RF amplifiers (RF AMP) to amplify electrical signals. The optical amplifiers may further provide any dispersion properties. FIG. 4 further depicts polarization controllers (PC) providing polarization control. Although not explicitly shown, the amplified pulses exiting optical amplifier 412 may further be compressed by a short length of single mode fiber.

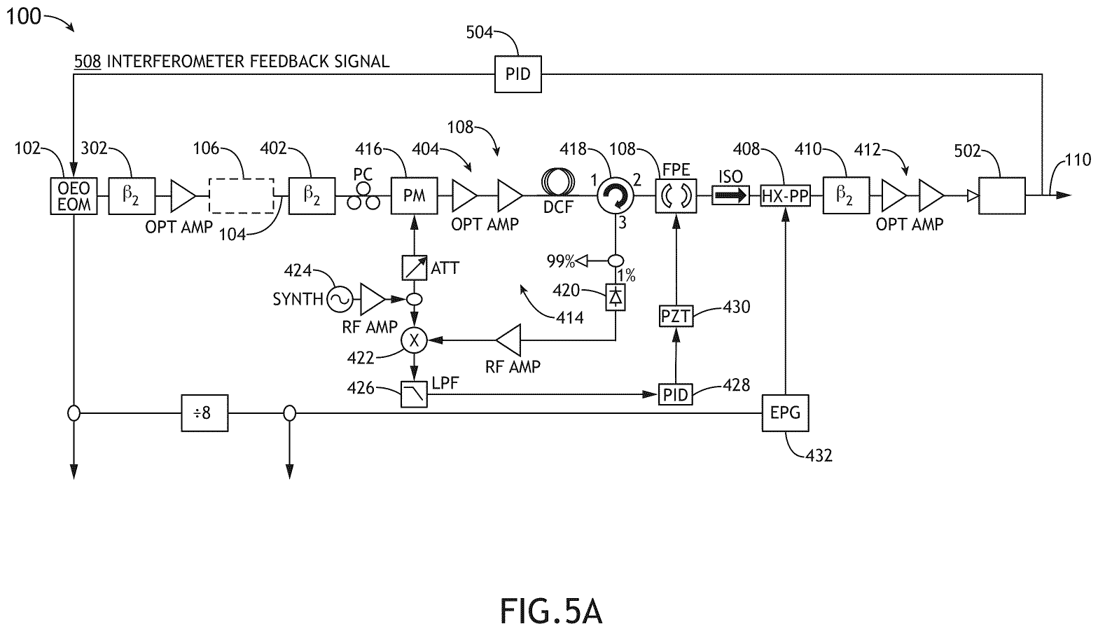

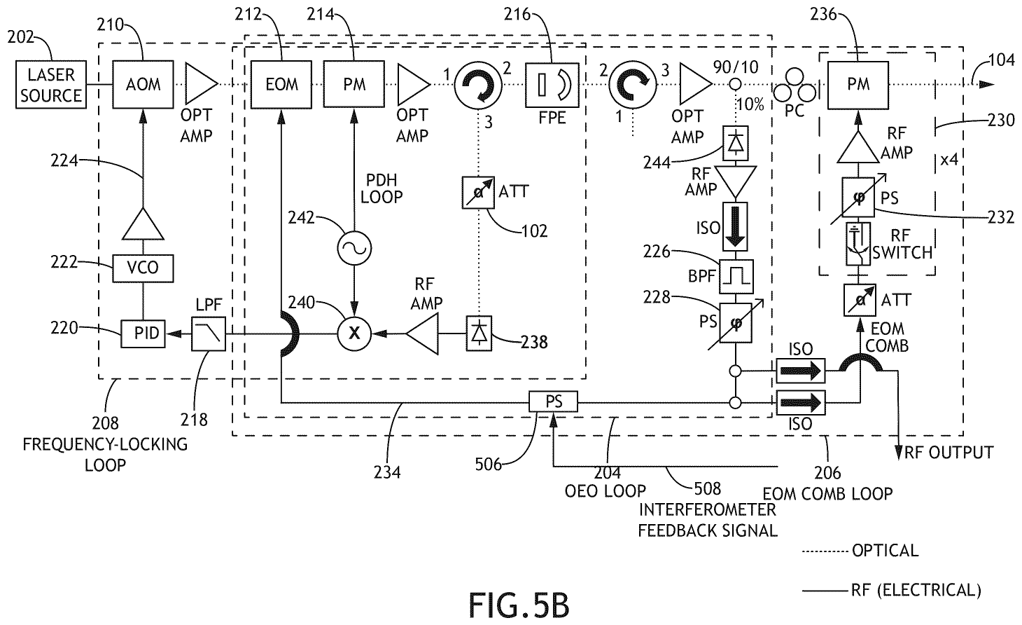

Referring now to FIGS. 5A-5B, carrier offset detection for the measurement of an absolute frequency offset of the EOM comb 104 is described, in accordance with one or more embodiments of the present disclosure.

FIG. 5A illustrates a block diagram of a portion of the comb-generation system 100 including an interferometer 502 for carrier envelope offset detection, in accordance with one or more embodiments of the present disclosure. FIG. 5A is substantially the same as FIG. 4 except for the addition of the interferometer 502.

In some cases, the output EOM comb 110 may be directed into the interferometer 502 for detecting a carrier envelope offset signal associated with the output EOM comb 110. The interferometer 502 may include various optical and electronic components to measure and analyze the carrier envelope offset. For example, the interferometer 502 may be a f to 2 f interferometer. In some cases, the f to 2 f interferometer is a commercially available device such as, but not limited to, a commercial carrier offset stabilization module (COSMO).

In some embodiments, the output EOM comb 110 is sent into a nonlinear device within the interferometer 502 for spectral broadening. This nonlinear device may be an optical fiber, a periodically poled lithium niobate crystal, a tantala waveguide, or any other suitable device. The spectral broadening process may expand the bandwidth of the output EOM comb 110 to span more than one octave of optical bandwidth.

After spectral broadening, the interferometer 502 may employ a second harmonic crystal stage to frequency double the long wavelength region of the broadened spectrum. The frequency-doubled light may then interfere with light at the short wavelength end of the spectrum. This interference may produce a time-dependent modulation of light intensity that can be detected by a photodetector within the interferometer 502.

The modulation frequency detected by the photodetector may correspond to the carrier envelope offset signal. By measuring this beat signal along with the RF drive signal 234 from the OEO loop 204, the interferometer 502 may provide a measurement of the absolute optical frequency offset of the output EOM comb 110. This measurement may allow for precise knowledge of the exact optical frequencies in the output EOM comb 110, potentially to an accuracy of 10 Hz in some cases.

The carrier envelope offset detection provided by the interferometer 502 may also be used to stabilize the comb-generation system 100. FIG. 5B illustrates a block diagram of the EOM comb generator 102 with additional components for comb stabilization, in accordance with one or more embodiments of the present disclosure. FIG. 5B is substantially similar to FIG. 2 except that FIG. 5B includes a phase shifter 506 in a path of the RF drive signal 234.

As shown in FIGS. 5A and 5B, the carrier envelope offset measurement provided by the interferometer 502 may generate an interferometer feedback signal 508. This interferometer feedback signal 508 may be processed by a PID controller 504 and then provided to a phase shifter 506 in the EOM comb generator 102. The phase shifter 506 may adjust the phase of the RF drive signal 234 based on the interferometer feedback signal 508. This adjustment may help maintain temporal stability of the output EOM comb 110 by compensating for any drift in the carrier envelope offset. By incorporating this feedback mechanism, the comb-generation system 100 may achieve self-referencing and self-stabilization without the need for external references. This may result in a robust and stable optical frequency comb system suitable for a wide range of precision applications.

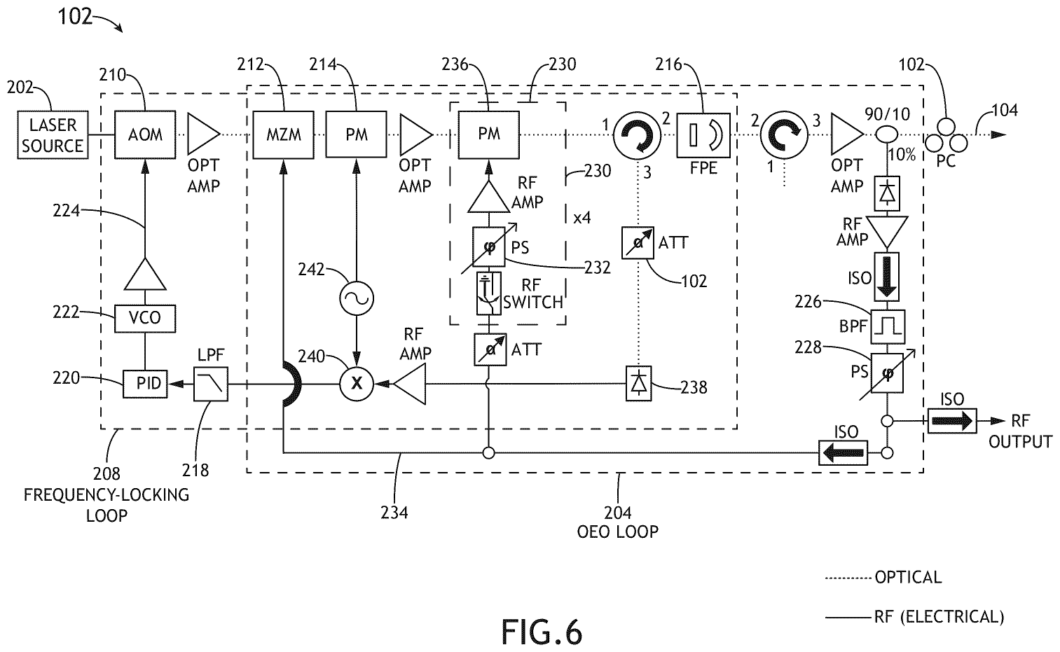

Referring now to FIG. 6, an alternative configuration of the comb-generation system 100 and EOM comb generator 102 are described, in accordance with one or more embodiments of the present disclosure.

FIG. 6 illustrates an alternative configuration of the EOM comb generator 102, in accordance with one or more embodiments of the present disclosure. FIG. 6 is substantially the same as FIG. 2 except that the cascading phase shifting units 230 are placed prior to the periodic optical filter 216. Specifically, FIG. 6 depicts the cascading phase shifting units 230 placed between the phase modulator 214 and the periodic optical filter 216.

In some cases, the placement of the cascading phase shifting units 230 prior to the periodic optical filter 216 may offer certain advantages or differences compared to the configuration shown in FIG. 2. For example, this arrangement may allow for the phase modulation to be applied to the optical signal before it enters the periodic optical filter 216 such that the periodic optical filter 216 may filter the entire EOM comb 104. As a result, this arrangement may negate the need for the tunable filter 108 depicted in FIGS. 1, 4 and 5A.

The configuration shown in FIG. 6 may also influence the efficiency of the comb generation process. By modulating the optical signal before it enters the periodic optical filter 216, the interaction between the modulated sidebands and the filter resonances may be modified, potentially leading to changes in the comb generation efficiency or the achievable comb bandwidth.

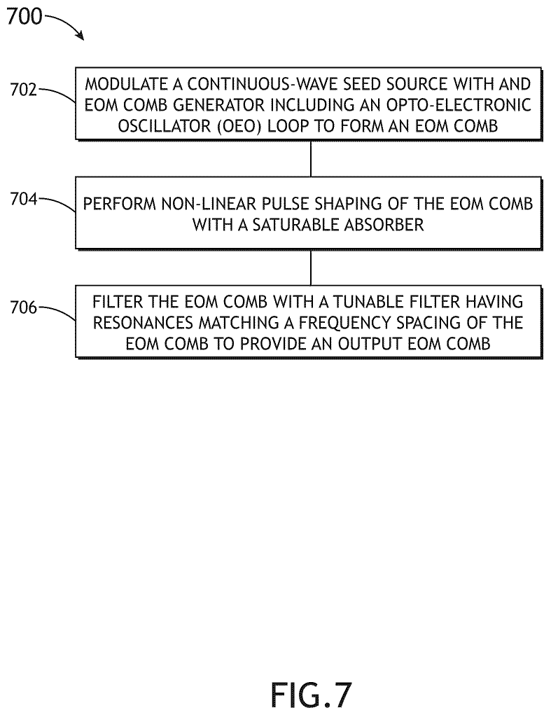

FIG. 7 illustrates a flowchart of a method 700 for generating an optical frequency comb, in accordance with one or more embodiments of the present disclosure.

In step 702, a continuous-wave seed source is modulated with an electro-optic modulated (EOM) comb generator including an opto-electronic oscillator (OEO) loop to form an EOM comb. This step may involve using the EOM comb generator 102 as described in relation to FIG. 2 or FIG. 6, where the OEO loop 204 generates an RF drive signal to modulate the continuous-wave seed source from the laser source 202.

In step 704, non-linear pulse shaping of the EOM comb is performed with a saturable absorber. This step may utilize the saturable absorber 106 as described in relation to FIG. 3, which may be implemented as a nonlinear amplifying loop mirror (NALM) to suppress pulse pedestals and reshape the pulses of the EOM comb.

In step 706, the EOM comb is filtered with a tunable filter having resonances matching a frequency spacing of the EOM comb to provide an output EOM comb. This step may involve using the tunable filter 108 as described in relation to FIG. 4, where the cavity resonances are adjusted to align with the comb spacing, allowing for filtering and potential stabilization of the comb lines.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system, comprising:
an electro-optic modulated (EOM) comb generator including an opto-electronic oscillator (OEO) loop to modulate a continuous-wave seed source and form an EOM comb;
a saturable absorber to perform non-linear pulse shaping of the EOM comb; and
a tunable filter having resonances matching a frequency spacing of the EOM comb, wherein the tunable filter filters the EOM comb from the saturable absorber to provide an output EOM comb.

2. The system of claim 1, further comprising:
an interferometer for detecting a carrier envelope offset signal associated with the output EOM comb.

3. The system of claim 2, wherein the interferometer provides a feedback signal to the EOM comb generator for temporal stability.

4. The system of claim 2, wherein the interferometer provides a measurement of an absolute optical frequency offset of the output EOM comb.

5. The system of claim 1, further comprising:
an amplifier to amplify the EOM comb from the tunable filter.

6. The system of claim 5, further comprising:
a pulse picker between the tunable filter and the amplifier to selectively pick pulses in the output EOM comb.

7. The system of claim 5, further comprising:
a dispersive filter between the tunable filter and the amplifier.

8. The system of claim 7, wherein the dispersive filter comprises:
a spatial light modulator.

9. The system of claim 1, wherein the saturable absorber comprises:
a nonlinear amplifying loop mirror (NALM).

10. The system of claim 1, wherein the tunable filter comprises:
a stationary mirror; and
a movable mirror parallel to the stationary mirror, where a separation distance between the stationary mirror and the movable mirror is adjustable.

11. The system of claim 10, wherein the separation distance between the stationary mirror and the movable mirror is controlled to match cavity resonances of the tunable filter with the output EOM comb.

12. The system of claim 1, wherein the EOM comb generator comprises:
a light source to generate an optical signal;
an intensity modulator to modulate an intensity of the optical signal from the light source based on a radio-frequency (RF) drive signal;
a frequency-locking loop to maintain an optical frequency of the optical signal at a target optical frequency, wherein the target optical frequency corresponds to a resonance frequency of a periodic optical filter in the frequency-locking loop;
an optoelectronic oscillator (OEO) loop comprising:
a photodetector to generate the RF drive signal from a portion of the optical signal from the frequency-locking loop; and
a tunable phase shifter to introduce a phase shift to the RF drive signal to select a resonance frequency of the OEO loop corresponding to a harmonic of the resonance frequency of the periodic optical filter, wherein the RF drive signal includes the resonance frequency of the OEO loop; and
one or more phase modulators in series to generate the EOM comb by modulating a portion of the optical signal from the frequency-locking loop based on the RF drive signal.

13. A system, comprising:
an electro-optic modulated (EOM) comb generator including an opto-electronic oscillator (OEO) loop to modulate a continuous-wave seed source and form an EOM comb, wherein the EOM comb generator comprises:
a light source to generate an optical signal;
an intensity modulator to modulate an intensity of the optical signal from the light source based on a radio-frequency (RF) drive signal;
a frequency-locking loop to maintain an optical frequency of the optical signal at a target optical frequency, wherein the target optical frequency corresponds to a resonance frequency of a periodic optical filter in the frequency-locking loop, wherein the frequency-locking loop includes one or more phase modulators in series prior to the periodic optical filter to modulate a portion of the optical signal based on the RF drive signal to produce the EOM comb; and
an optoelectronic oscillator (OEO) loop comprising:
a photodetector to generate the RF drive signal from a portion of the EOM comb from the frequency-locking loop; and
a tunable phase shifter to introduce a phase shift to the RF drive signal to select a resonance frequency of the OEO loop corresponding to a harmonic of the resonance frequency of the periodic optical filter, wherein the RF drive signal includes the resonance frequency of the OEO loop; and
a saturable absorber to perform non-linear pulse shaping of the EOM comb to provide an output EOM comb.

14. The system of claim 13, further comprising:
an interferometer for detecting a carrier envelope offset signal associated with the output EOM comb.

15. The system of claim 14, wherein the interferometer provides a feedback signal to the EOM comb generator for temporal stability.

16. The system of claim 14, wherein the interferometer provides a measurement of an absolute optical frequency offset of the output EOM comb.

17. The system of claim 13, wherein the saturable absorber comprises:
a nonlinear amplifying loop mirror (NALM).

18. The system of claim 13, wherein the tunable filter comprises:
a stationary mirror; and
a movable mirror parallel to the stationary mirror, where a separation distance between the stationary mirror and the movable mirror is adjustable.

19. The system of claim 18, wherein the separation distance between the stationary mirror and the movable mirror is controlled to match cavity resonances of the tunable filter with the output EOM comb.

20. A method, comprising:
modulating a continuous-wave seed source with an electro-optic modulated (EOM) comb generator including an opto-electronic oscillator (OEO) loop to form an EOM comb;
performing non-linear pulse shaping of the EOM comb with a saturable absorber; and
filtering the EOM comb with a tunable filter having resonances matching a frequency spacing of the EOM comb to provide an output EOM comb.

21. The method of claim 20, further comprising:
amplifying the output EOM comb.
